(19) United States
(12) Patent Application Publication
(10) Pub. No.: US 2005/0025243 A1
(43) Pub. Date: Feb. 3, 2005

(54) Motion type decision apparatus and method thereof

(75) Inventors: Young-wook Sohn, Seoul (KR); Sung-hee Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/887,915

(22) Filed: Jul. 12, 2004

(30) Foreign Application Priority Data
Jul. 31, 2003 (KR) 2003-53230

(51) Int. Cl. H04N 7/12

(52) U.S. Cl. 375/240.16; 375/240.24

(57) ABSTRACT

A motion type decision apparatus and method thereof are provided. A first decision unit determines the presence of motion in a current block for compensation, by extracting first and second high frequency signals from first and second blocks of a previous and a current frame/fields corresponding to a zero motion vector of the current block to set a first threshold, and comparing a first motion estimation error value between the first and the second blocks with the first threshold. A second decision unit determines the presence of motion in the current block, by extracting third and fourth high frequency signals from third and fourth blocks, setting a second threshold, and comparing a second motion estimation error value with the second threshold. A motion type decision unit determines a motion type of the current block by comparing the motion determinations of the first and the second decision units.

### CROSS-REFERENCE TO RELATED APPLICATIONS

This application claims the benefit of Korean Patent Application No. 2003-53230 filed Jul. 31, 2003, in the Korean Intellectual Property Office, the disclosure of which is incorporated herein by reference.

### BACKGROUND

1. Field of the Invention

The present invention relates to an apparatus and a method for motion type decision, and more particularly, to a motion type decision apparatus and method thereof, which decides the motion type of a current block for compensation, by considering a zero motion vector of the current block and motion vectors which are estimated by block matching.

2. Description of the Related Art

In a general image processing operation such as a frame rate up-conversion (FRC) or an interlaced to progressive conversion (IPC), motion estimation among image frames is essentially required. The motion estimation refers to a process which estimates motion vectors for motion compensation, and is usually performed using a block matching algorithm (BMA).

The BMA compares the two successively inputted frame/fields in a block unit, and estimates a single motion vector for each block. The motion vector is estimated by using a motion estimation error value, such as a sum of absolute difference (SAD). Accordingly, such estimated motion vectors are used in the motion compensation process.

However, in the conventional motion estimation, motion vectors estimated for the respective blocks were often inaccurate, and when this happened, there occurred a block artifact in an interpolated frame/field image as shown in FIG. 1 as the motion compensating process is performed using inaccurate motion vectors. The block artifact is the blurring phenomenon shown usually in the borderline between adjacent blocks, resulting in unpleasant view of discontinuous borders and subsequent image quality degradation. As described above, the phenomenon like block artifact occurs as the motion compensation is performed for the respective blocks using estimated motion vectors without considering the correlativity among the adjacent blocks.

### SUMMARY

In an effort to overcome the problems as mentioned above, it is one aspect of the present invention to provide a motion type decision apparatus and a method thereof, which decides a motion type of a predetermined block for compensation, so as to select a motion compensation method that is best suitable for removing problems such as a block artifact which occurs due to inaccurate estimation of motion vectors of the block.

The above aspects and/or other features of the present invention can substantially be achieved by providing a motion type decision apparatus, comprising: a first decision unit to determine the presence of motion in a current block for compensation, by extracting first and second high frequency signals from a first block and a second block of a previous and a current frame/fields corresponding to a zero motion vector of the current block to set a first threshold, and comparing a first motion estimation error value between the first and the second blocks with the first threshold; a second decision unit to determine the presence of motion in the current block, by extracting third and fourth high frequency signals from a third block and a fourth block of the previous and the current frame/fields corresponding to a motion vector, which is estimated for the compensation of the current block, to set a second threshold, and comparing a second motion estimation error value between the third and the fourth blocks with the second threshold; and a motion type decision unit to determine a motion type of the current block by comparing the determination on the presence of motion by the first and the second decision units.

The first decision unit comprises: a first high pass filter to extract the first and the second high frequency signals which exceed a predetermined frequency, by filtering the first and the second blocks, respectively; a first threshold setting unit to set at least one of the extracted first and second high frequency signals as the first threshold to determine the presence of motion in the current block; and a first motion decision unit to determine that a motion exists in the current block when the calculated first motion estimation error value exceeds the first threshold.

The second decision unit comprises: a second high pass filter to extract the third and the fourth high frequency signals which exceed a predetermined frequency, by filtering the third and the fourth blocks, respectively; a second threshold setting unit to set at least one of the extracted third and fourth high frequency signals as the second threshold to determine the presence of motion in the current block; and a second motion decision unit to determine that the motion exists in the current block when the calculated second motion estimation error value exceeds the second threshold.

The first decision unit sets the first threshold by adding at least one of the first and second high frequency signals with a predetermined noise signal, and the second decision unit sets the second threshold by adding at least one of the third and fourth high frequency signals with a predetermined noise signal.

The first decision unit sets the first threshold by adding a larger signal of the first and second high frequency signals with the noise signal, and the second decision unit sets the second threshold by adding a larger signal of the third and fourth high frequency signals with the noise signal.

When the first and second decision units determine the motion of the current block to be non-zero and zero, respectively, the motion type decision unit determines that the motion type of the current block is global motion, and that the estimated motion vector is accurate.

When the first and second decision units determine the motion of the current block to be non-zero, respectively, the motion decision unit determines that a motion exists in the current block but the estimated motion vector is inaccurate.

The estimated motion vector is estimated from a location having a minimum motion estimation error value among a plurality of motion estimation error values which are calculated by applying one of a bi-directional block matching and a unidirectional block matching.

The first and second motion estimation error values are calculated by one among a sum of absolute difference (SAD), a mean absolute difference (MAD) and a mean square error (MSE).

According to one aspect of the present invention, a motion type decision method comprises a first decision step of determining the presence of motion in a current block for compensation, by extracting first and second high frequency signals from a first block and a second block of a previous and a current frame/fields corresponding to a zero motion vector of the current block to set a first threshold, and comparing a first motion estimation error value between the first and the second blocks with the first threshold; a second decision step of determining the presence of motion in the current block, by extracting third and fourth high frequency signals from a third block and a fourth block of the previous and the current frame/fields corresponding to a motion vector, which is estimated for the compensation of the current block, to set a second threshold, and comparing a second motion estimation error value between the third and the fourth blocks with the second threshold; and a motion type decision step of determining a motion type of the current block by comparing the determination on the presence of motion by the first and the second decision steps.

The first decision step comprises: a first filtering step of extracting the first and the second high frequency signals which exceed a predetermined frequency, by filtering the first and the second blocks, respectively; a first threshold setting step of setting at least one of the extracted first and second high frequency signals as the first threshold to determine the presence of motion in the current block; and a first motion decision step of determining that a motion exists in the current block when the calculated first motion estimation error value exceeds the first threshold. The second decision step comprises: a second filtering step of extracting the third and the fourth high frequency signals which exceed a predetermined frequency, by filtering the third and the fourth blocks, respectively; a second threshold setting step of setting at least one of the extracted third and fourth high frequency signals as the second threshold to determine the presence of motion in the current block; and a second motion decision step of determining that the motion exists in the current block when the calculated second motion estimation error value exceeds the second threshold.

### BRIEF DESCRIPTION OF THE DRAWINGS

The above aspects and other features of the present invention will become more apparent by describing in detail exemplary embodiments thereof with reference to the attached drawings, in which:

FIG. 1 is a view illustrating a simulation image where a block artifact occurs in a conventional motion compensation;

FIG. 2 is a block diagram schematically illustrating a motion-type adaptive motion compensation selecting apparatus according to a first exemplary embodiment of the present invention;

FIG. 3 is a block diagram illustrating in detail the motion decision unit of FIG. 2;

FIGS. 4A to 4C are views illustrating the operation of the motion estimation unit of the apparatus of FIG. 2;

FIG. 5 is a view illustrating an occlusion motion which is decided at the motion type decision unit of FIG. 2;

FIG. 6 is a view illustrating an OBMC method, which is applied to remove the block artifacts;

FIG. 7 is a view illustrating a simulation image in which the block artifact has been removed by FIG. 2;

FIG. 8 is a flowchart for illustrating a motion type decision method for the apparatus of FIG. 2; and

FIG. 9 is a block diagram schematically illustrating a motion-type adaptive motion vector filter apparatus according to a second exemplary embodiment of the present invention.

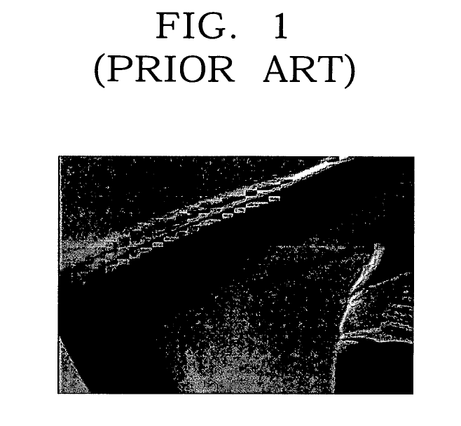

### DETAILED DESCRIPTION OF THE ILLUSTRATIVE, NON-LIMITING EMBODIMENTS

Hereinafter, the present invention will be described in detail with reference to the accompanying drawings.

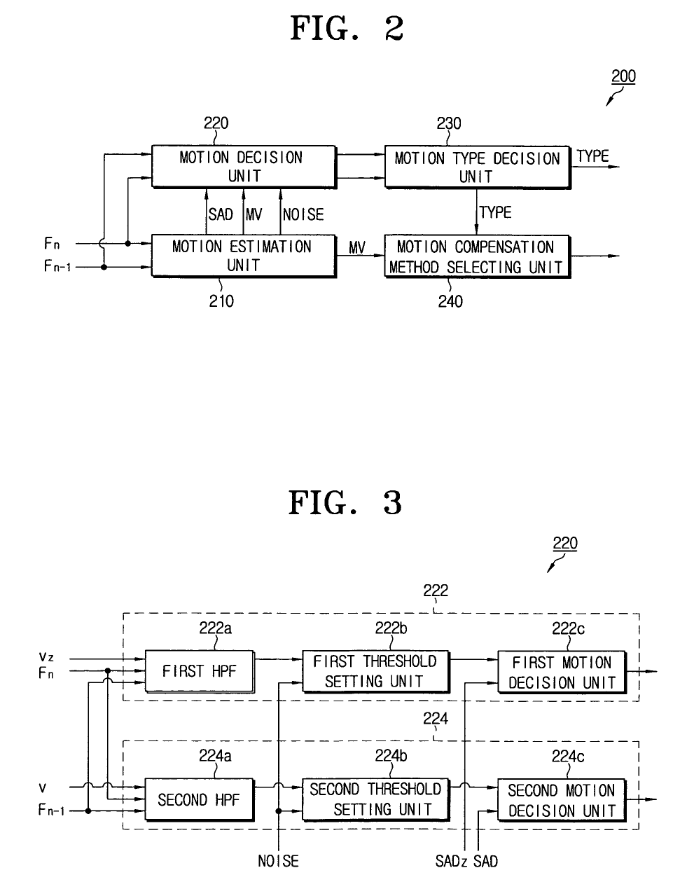

FIG. 2 is a block diagram schematically illustrating a motion-type adaptive motion compensation selecting apparatus according to a first exemplary embodiment of the present invention, and FIG. 3 is a block diagram illustrating in detail the motion decision unit of FIG. 2.

Referring to FIG. 2, a motion-type adaptive motion compensation selecting apparatus 200 according to the present invention includes a motion estimation unit 210, a motion decision unit 220, a motion type decision unit 230 and a motion compensation method selecting unit 240. The motion decision unit 220 and the motion type decision unit 230 of FIG. 2 are applied as a motion type decision apparatus according to the present invention.

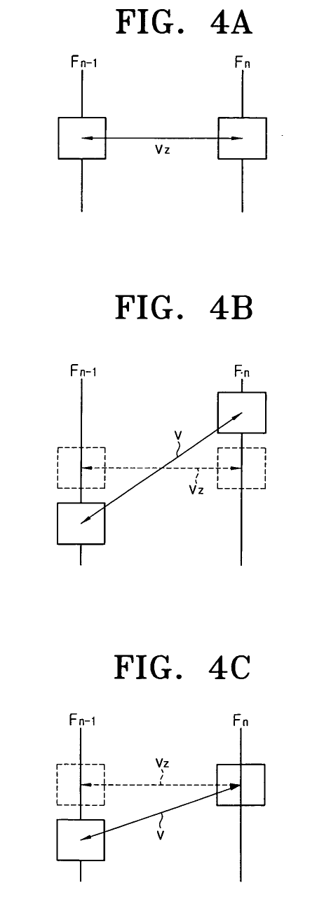

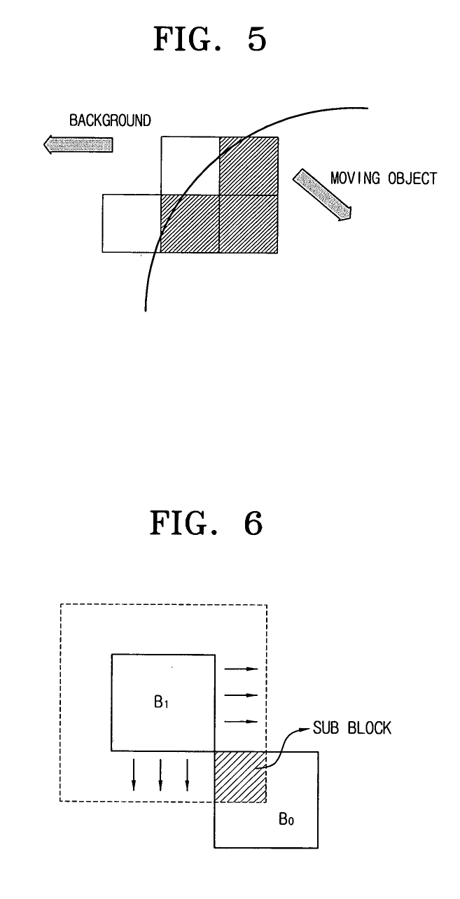

The motion estimation unit 210 divides a currently-input frame/field (hereinafter briefly called ‘current frame Fₙ’) into blocks of a predetermined size, and calculates motion estimation error values from blocks of previously-input frame/field (hereinafter briefly called ‘previous frame Fₙ₋₁’) which correspond to zero motion vectors v_{z} of the blocks of the current frame Fₙ (FIG. 4A).

The motion estimation unit 210 also estimates motion vectors v of the respective blocks of the current frame Fₙ. In the present embodiment, the motion estimation unit 210 applies a bi-directional BMA as shown in FIG. 4B to the blocks and the previous frame Fₙ₋₁, respectively. After calculating a plurality of motion estimation error values of the respective blocks, the motion estimation unit 210 estimates motion vectors v of the respective blocks from the position having minimum motion estimation error.

Besides the bidirectional BMA, other various known techniques such as a unidirectional BMA as shown in FIG. 4C can be applied to estimate motion vectors v of the blocks.

Meanwhile, the motion estimation error values can be calculated by various methods such as a sum of absolute difference (SAD), a mean absolute difference (MAD) and a mean square error (MSE), and among these, the SAD is applied in the present embodiment. Accordingly, the motion estimation error will be called a ‘SAD’ hereinafter.

The zero motion vectors v_{z} of the current block for compensation, the estimated motion vectors v, the SAD (SAD_{z}) corresponding to the zero motion vector v_{z} and the SAD (SADᵥ) corresponding to the estimated motion vectors v, are provided to the motion decision unit 220.

The motion decision unit 220 determines whether there is a motion in the current block. More specifically, the motion decision unit 220 extracts a high frequency component from the input image, adds the extracted high frequency component with a noise component and accordingly sets a predetermined threshold. The motion decision unit 220 compares the set threshold with the SADs of the current block which are provided from the motion estimation unit 210, and accordingly determines whether there is a motion in the current block. To this end, the motion decision unit 220 includes a first decision unit 222 and a second decision unit 224 (FIG. 3).

The first decision unit 222 includes a first high pass filter (hereinafter briefly called ‘first HPF’) 222a, a first threshold setting unit 222b and a first motion decision unit 222c.

As shown in FIG. 4A, the first HPF 222a extracts first and second high frequency components exceeding a predetermined frequency, by filtering a first block B1 of the previous frame Fₙ₋₁ corresponding to the zero motion vector v_{z} of the current block, and a second block B2 of the current frame Fₙ corresponding to the zero motion vector v_{z}.

The first threshold setting unit 222b sets a first threshold, by using at least one among the extracted first and second high frequency signals. The first threshold is a reference value for determining the presence of motion in the current block. According to the present invention, the first threshold setting unit 222b sets the first threshold by using a mathematical formula as follows:
ε(v_{z})=Max{H(f(x+v_{z},n−1)),H(f(x+v_{z},n))}+α [Formula 1]

wherein, ε(v_{z}) is a first threshold, H(f(x+v_{z}, n−1)) and H(f(x+v_{z},n)) are first and second high frequency signals of the first HPF, v_{z} is a zero motion vector of the current block, Max{H(f(x+v_{z}, n−1)), H(f(x+v_{z}, n))} represent a gradient, and α is a noise signal. In other words, α is a predetermined constant which represents the degree of noise distribution in an image, and a parameter that is variable in accordance with the characteristics of the image. Referring to Formula 1, the first threshold setting unit 222b adds the larger one of the first and the second high frequency signals with a predetermined noise signal, and accordingly sets a first threshold.

The first motion decision unit 222c compares the first SADs between the first and the second blocks B1, B2 to determine the presence of motion in the current block. That is, the first motion decision unit 222c compares the SAD (SAD_{z}) with the first threshold to determine the presence of motion in the current block. This can be expressed as the following:

$$m = \{ \begin{matrix}zero , & if Φ ( {v}_{z} ) \leq ɛ ( {v}_{z} ) , \\ non - zero , & otherwise\end{matrix} \qquad [ Formula 2 ]$$

wherein, m represents the presence of motion, (Φv_{z}) is a SAD corresponding to the zero motion vector v_{z}, zero refers to no motion in the current block, and non-zero refers to the presence of motion in the current block. More specifically, if the first SAD is not more than the first threshold, the first motion decision unit 222c, in comparing the previous frame Fₙ₋₁ with the first block B1, determines that there is no motion in the current block, while the first motion decision unit 222c determines there is motion in the current block by comparing the first SAD with the first block B1, if the first SAD exceeds the first threshold.

The second decision unit 224 includes a second HPF 224a, a second threshold setting unit 224b and a second motion decision unit 224c.

As shown in FIG. 4B, the second HPF 224a extracts third and fourth high frequency signals exceeding a predetermined frequency, by filtering the third block B3 of the previous frame Fₙ₋₁ with the fourth block B4 of the current frame F_{z}, which corresponds to the current block by the bi-directional motion vector. Here, the fourth block B4 is the current block.

The second threshold setting unit 224b sets a second threshold by using at least one of the third and the fourth high frequency signals as extracted. The second threshold is a reference for determining the presence of motion in the current block. According to the present invention, the second threshold setting unit 224b sets a second threshold by using a following mathematical formula:
ε(v)=Max{H(f(x+v,n−1)),H(f(x+v, n))}+α [Formula 3]

wherein, ε(v) is a second threshold, H(f(x+v, n−1) and H(f(x+v, n)) are third and fourth high frequency signals of the second HPF, v is an estimated motion vector of the current block, Max {H(f(x+v, n−1), H(f(x+v, n))) represents a gradient, and α is a parameter which represents the degree of noise distribution in an image. Referring to Formula 3, the second threshold setting unit 224b adds the larger one of the third and the fourth high frequency signals with a predetermined noise signal, and accordingly sets a second threshold.

The second motion decision unit 224c determines the presence of motion in the current block by comparing the second SADs of the third and the fourth blocks. That is, the second motion decision unit 224c compares the SAD (SADᵥ) with the second threshold, and accordingly determines whether there is motion in the current block. This can be expressed as the following:

$$m = \{ \begin{matrix}zero , & if Φ ( v ) \leq ɛ ( v ) , \\ non - zero , & otherwise\end{matrix} \qquad [ Formula 4 ]$$

wherein, m represents the presence of motion, Φ(v) is a SAD corresponding to the estimated motion vector v, zero means no motion in the current block, and non-zero means the motion in the current block. Therefore, if the second SAD is not more than the second threshold, the second motion decision unit 224c, in comparing with the third block B3 of the previous frame Fₙ₋₁, determines there is no motion in the current block, while the second motion decision unit 224c determines there is motion when the second SAD exceeds the second threshold.

Referring again to FIG. 2, the motion type decision unit 230 determines the motion type of the current block by the following Table 1.

TABLE 1

Result from 2nd motion
decision unit

| | | Zero | Non-zero |
|---|---|---|---|
| Result from 1st | Zero | Unknown | Zero |
| motion decision | Non-zero | Global | Deformable |
| unit | | | |

The operation of the motion type decision unit 230 will be described in greater detail below with reference to Table 1.

First, when determining by the first and the second motion decision units 222c, 224c that there is zero motion in the current block, this means that no motion exists in the current block and the estimated motion vector v is accurate. In this case, the motion type decision unit 230 can not determine the motion type of the current block, and therefore, defines such motion to be ‘unknown’. This type of motion usually occurs in a smooth image.

Second, when determining zero and non-zero motion from the first and the second motion decision units 222c, 224c, respectively, the motion type decision unit 230 determines that there is a still motion in the current block. That is, the motion type decision unit 230 determines the current block defined to be ‘zero’ as the still image.

Third, when determining non-zero and zero motion from the first and the second motion decision units 222c, 224c, respectively, the motion type decision unit 230 determines that the current block is of a global motion type. This applies to the BMA model, in which motion exists in the current block and the estimated motion vector v is accurate. The ‘global motion’ is very suitable for the translation motion model.

Fourth, when determining non-zero motion in the current block from the first and the second motion decision units 222c, 224c, the motion type decision unit 230 determines that the motion in the current block is not suitable for the translation motion model. This means that, the motion exists in the current block, but the motion vector v is estimated inaccurately and therefore unsuitable for the BMA model. This type of the motion is defined to be ‘deformable’. The ‘deformable’ motion type usually occurs when the current block is positioned in the occlusion region, or boundary region of moving images. The ‘occlusion region’ refers to a region where the movement direction of the background image crosses the movement direction of the moving object (see FIG. 5), and the motion occurring in the occlusion region is occlusion motion.

The motion vector v of the current block, which is estimated by the motion estimation unit 210, and the motion type of the current block which is determined by the motion type decision unit 230, are provided to the motion compensation method selecting unit 240. According to the motion type as determined, the motion compensation method selecting unit 240 selects and applies one among the simple motion compensation method and the Overlap Block Motion Compensation (OBMC) as the motion compensation method with respect to the current block.

For example, if the motion type decision unit 230 determines a ‘deformable’ motion type as shown in FIG. 5 for the current block, the motion compensation method selecting unit 240 selects the OBMC as the motion compensation method for the current block. This is because applying a simple motion compensation method with respect to the block having occlusion motion would cause block artifacts in the image.

The OBMC uses a certain characteristic that the motion vector v of the current block has high correlativity with the motion vectors (not shown) of adjacent blocks. More specifically, the OBMC extends a certain adjacent block B1 in horizontal/vertical direction indicated by arrows (see FIG. 6) to a predetermined size to partially overlap the current block B₀, and sets the overlapped block, i.e., the sub block (hatched area) as a basic unit of compensation. That is, based on the assumption that the motion vector v of the current block B₀, and the motion vector (not shown) of the adjacent block B₁, influence the motion compensation in the sub-block, the OBMC applies different weights to the respective locations of the sub block in performing motion compensation. Here, the adjacent block refers to at least one block that surrounds the current block.

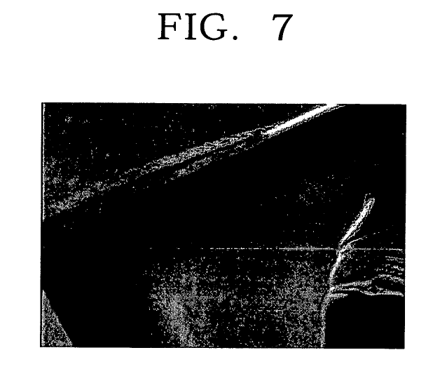

As the current block, having an occlusion region as shown in FIG. 5, is compensated by the OBMC, the image having a reduced, or even removed block artifact (see FIG. 7) can be obtained.

Meanwhile, if the motion type decision unit 230 determines the motion type of the current block as one among the ‘unknown’, ‘zero’ and ‘global’, the motion compensation method selecting unit 240 selects a simple motion compensation method for the current block. The simple motion compensation method performs interpolation by referring to the data, i.e., pixels, which correspond to the motion vectors v estimated from the previous frame Fₙ₋₁, or from the next frame (Fₙ₊₁).

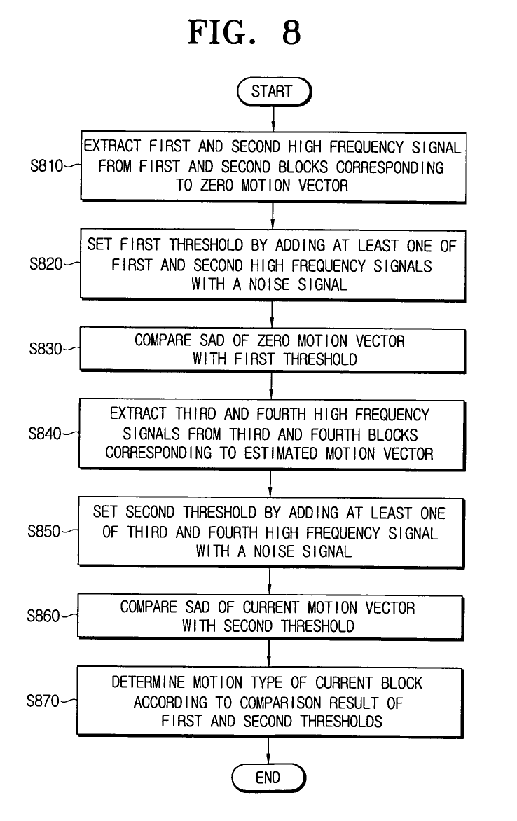

FIG. 8 is a flowchart schematically illustrating a motion type decision method of the apparatus as shown in FIG. 2.

Referring to FIGS. 2 to 8, first, the motion estimation unit 210 estimates a motion vector v of the current block of the current frame Fₙ, and provides the motion decision unit 220 with the estimated motion vector v, a motion estimation error with respect to the estimated motion vector v, a zero motion vector v_{z} of the current block and a motion estimation error with respect to the zero motion vector v_{z}.

The first HPF 222a of the motion decision unit 220 extracts first and second high frequency signals, by filtering the first block of the previous frame Fₙ₋₁ corresponding to the zero motion vector v_{z} and the second block of the current frame Fₙ (S810). After S810, the first threshold setting unit 222b sets a first threshold, by adding at least one of the first and second high frequency signals with a noise signal (S820). The first motion decision unit 220 compares the SAD (SAD_{z}) with respect to the zero motion vector v_{z} with the first threshold, and accordingly determines whether there is a motion in the current block (S830). If the SAD (SAD_{z}) with respect to the zero motion vector v_{z} exceeds the first threshold, the first motion decision unit 220 determines there is no motion in the current block.

Meanwhile, the second HPF 224a of the motion decision unit 220 extracts third and fourth high frequency signals, by filtering the third block of the previous frame Fₙ₋₁ corresponding to the estimated motion vector v of the current block, and the fourth block of the current frame Fₙ, respectively (S840). After S840, the second threshold setting unit 224b adds at least one of third and fourth high frequency signals with a noise signal and accordingly sets the second threshold (S850). The second motion decision unit 220 compares the SAD (SADᵥ) for the estimated motion vector with the second threshold, and accordingly determines whether there is a motion in the current block (S860). That is, in S860, the second motion decision unit 220 determines there is the motion in the current block when the SAD (SADᵥ) for the estimated motion vector v exceeds the second threshold.

After S860, the motion type decision unit 230 determines the motion type of the current block based on the decision result of S830 and S860 and referring to Table 1 (S870). Since the motion decision method of S810 to S870 has already been described with reference to FIGS. 2 to 7, the description thereof will be omitted.

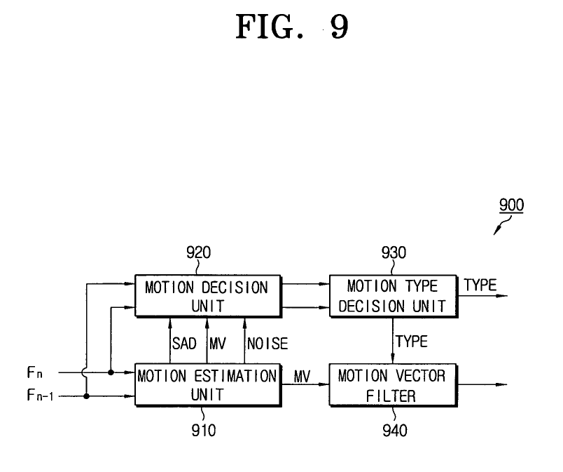

FIG. 9 is a block diagram schematically illustrating the motion-type adaptive motion vector filter apparatus according to the second exemplary embodiment of the present invention.

Referring to FIG. 9, the motion-type adaptive motion vector filter apparatus 900 according to the present invention includes a motion estimation unit 910, a motion decision unit 920, a motion type decision unit 930 and a motion vector filter 940.

The motion estimation unit 910, the motion decision unit 920 and the motion type decision unit 930 of FIG. 9 perform the similar, or identical operations as the motion estimation unit 210, the motion decision unit 220 and the motion type decision unit 230 of FIG. 2. Accordingly, description of the motion estimation unit 910, the motion decision unit 920 and the motion type decision unit 930 of FIG. 9 will be omitted.

The motion estimation unit 910 divides a current frame into blocks of a predetermined size, and calculates a minimum motion estimation error value of each block by applying bidirectional, or unidirectional BMA. As a result, the motion estimation unit 910 estimates motion vectors of the respective blocks. The motion estimation unit 910 also provides the motion decision unit 220 with a zero motion vector of the current block for compensation, a SAD (SAD_{z}) corresponding to the zero motion vector, and a SAD (SADᵥ) corresponding to the estimated motion vector.

The motion decision unit 920 comprises the first decision unit 222 and the second decision unit 224 as shown in FIG. 2.

The first decision unit 222 comprises a first HPF 222a, a first threshold setting unit 222b and a first motion decision unit 222c. The first HPF 222a extracts a high frequency component by filtering the blocks corresponding to the zero motion vectors. The first threshold setting unit 222b sets a first threshold by using the mathematical formula 1. The first motion decision unit 222c determines whether there is a motion in the current block or not, by using the mathematical formula 2.

The second decision unit 224 comprises a second HPF 224a, a second threshold setting unit 224b and a second motion decision unit 224c. The second HPF 224a extracts a high frequency component, by filtering the blocks corresponding to the estimated motion vectors. The second threshold setting unit 224b sets a second threshold, by using the mathematical formula 3. The second motion decision unit 224c determines whether there is a motion in the current block or not, by using the mathematical formula 4.

The motion type decision unit 930 determines the motion type of the current block based on the determination of the presence of motion by the first and the second motion decision units 222c, 224c and by referring to the table 1.

The motion vector filter 940 adaptively filters the estimated motion vector of the current block in accordance with the motion type of the current block which is determined by the motion type decision unit 930. For example, if the motion type decision unit 930 determines the motion type of the current block to be ‘deformable’, the motion vector filter 940 applies a ‘motion vector generation apparatus and method thereof’ which has been disclosed by the same applicant in the Korean Patent Application No. 2003-38794. To describe it in greater detail, the motion compensation, which is similar to OBMC, is performed with the motion vector generation apparatus and method thereof in the KR 2003-38794.

If the motion type decision unit 930 determines the motion type of the current block to be ‘unknown’, ‘zero’ or ‘global’, the motion vector filter 940 outputs the motion vector v as estimated by the motion estimation unit 910.

As described above, by adaptively filtering the motion vector which is estimated in accordance with the motion type of the current block, or filtering the zero motion vector, current block can be compensated with more accurate motion vectors. As a result, the final image of improved image quality is output to the screen (see FIG. 7).

Meanwhile, in both the motion-type adaptive motion compensation selecting apparatus 200 and the method thereof, and the motion vector filter apparatus 900 and the method thereof, the first and second threshold setting units 224a, 224b calculating the larger signal among the two high frequency signals, may also calculate the average or median value of the two high frequency signals and then add with a noise signal to set the first and second thresholds.

With the motion type decision apparatus and method thereof described so far according to the present invention, a motion type of the block for compensation can be determined in consideration of the motion vector which is estimated by a zero motion vector and a predetermined technique. In other words, after extracting the high frequency signal from the inputted signals, the extracted high frequency signal is added with a predetermined noise signal and a threshold is set accordingly. Then, the motion type of the block for compensation is determined through the comparison of the motion estimation error values, which are calculated in the motion estimation of the block for compensation, with the set threshold. As a motion compensation or motion vector filtering is performed adaptively in accordance with the motion type as determined, motion estimation and compensation efficiency improves, and as a result, image quality deteriorating causes such as block artifact can be avoided.

Although a few exemplary embodiments of the present invention have been described, it will be understood by those skilled in the art that the present invention should not be limited to the described exemplary embodiments, but various changes and modifications can be made within the spirit and scope of the present invention as defined by the appended claims.

1. A motion type decision apparatus, comprising:
a first decision unit to determine the presence of motion in a current block for compensation, by extracting a first high frequency signal and a second high frequency signal from a first block and a second block of a previous and a current frame corresponding to a zero motion vector of the current block to set a first threshold, and comparing a first motion estimation error value between the first and the second blocks with the first threshold;
a second decision unit to determine the presence of motion in the current block, by extracting a third high frequency signal and a fourth high frequency signal from a third block and a fourth block of the previous and the current frame corresponding to a motion vector, which is estimated for the compensation of the current block, to set a second threshold, and comparing a second motion estimation error value between the third and the fourth blocks with the second threshold; and
a motion type decision unit to determine a motion type of the current block by comparing the determination on the presence of motion by the first and the second decision units.

2. The motion type decision apparatus of claim 1, wherein the first decision unit comprises:
a first high pass filter to extract the first and the second high frequency signals which exceed a predetermined frequency, by filtering the first and the second blocks, respectively;
a first threshold setting unit to set at least one of the extracted first and second high frequency signals as the first threshold to determine the presence of motion in the current block; and
a first motion decision unit to determine that the motion exists in the current block when the calculated first motion estimation error value exceeds the first threshold.

3. The motion type decision apparatus of claim 1, wherein the second decision unit comprises:
a second high pass filter to extract the third and the fourth high frequency signals which exceed a predetermined frequency, by filtering the third and the fourth blocks, respectively;
a second threshold setting unit to set at least one of the extracted third and fourth high frequency signals as the second threshold to determine the presence of motion in the current block; and
a second motion decision unit to determine that the motion exists in the current block when the calculated second motion estimation error value exceeds the second threshold.

4. The motion type decision apparatus of claim 1, wherein the first decision unit sets the first threshold by adding at least one of the first and second high frequency signals with a predetermined noise signal, and the second decision unit sets the second threshold by adding at least one of the third and fourth high frequency signals with the predetermined noise signal.

5. The motion type decision apparatus of claim 4, wherein the first decision unit sets the first threshold by adding a larger signal of the first and second high frequency signals with the noise signal, and the second decision unit sets the second threshold by adding a larger signal of the third and fourth high frequency signals with the noise signal.

6. The motion type decision apparatus of claim 1, wherein, when the first and second decision units determine the motion of the current block to be non-zero and zero, respectively, the motion type decision unit determines that the motion type of the current block is global motion, and that the estimated motion vector is accurate.

7. The motion type decision apparatus of claim 1, wherein, when the first and second decision units determine the motion of the current block to be non-zero, respectively, the motion decision unit determines that a motion exists in the current block but the estimated motion vector is inaccurate.

8. The motion type decision apparatus of claim 7, wherein the motion type decision unit determines that the current block is an image positioned in an occlusion region of a moving image.

9. The motion type decision apparatus of claim 1, wherein the estimated motion vector is estimated from a location having a minimum motion estimation error value among a plurality of motion estimation error values which are calculated by applying one of a bi-direction block matching and a unidirectional block matching.

10. The motion type decision apparatus of claim 1, wherein the first and second motion estimation error values are calculated by one among a sum of absolute difference (SAD), a mean absolute difference (MAD) and a mean square error (MSE).

11. A motion type decision method, comprising:
a first decision step of determining the presence of motion in a current block for compensation, by extracting a first high frequency signal and a second high frequency signal from a first block and a second block of a previous and a current frame corresponding to a zero motion vector of the current block to set a first threshold, and comparing a first motion estimation error value between the first and the second blocks with the first threshold;
a second decision step of determining the presence of motion in the current block, by extracting a third high frequency signal and a fourth high frequency signal from a third block and a fourth block of the previous and the current frame corresponding to a motion vector, which is estimated for the compensation of the current block, to set a second threshold, and comparing a second motion estimation error value between the third and the fourth blocks with the second threshold; and
a motion type decision step of determining a motion type of the current block by comparing the determination of the presence of motion by the first and the second decision steps.

12. The motion type decision method of claim 11, wherein the first decision step comprises:
a first filtering step of extracting the first and the second high frequency signals which exceed a predetermined frequency, by filtering the first and the second blocks, respectively;
a first threshold setting step of setting at least one of the extracted first and second high frequency signals as the first threshold to determine the presence of motion in the current block; and
a first motion decision step of determining that a motion exists in the current block when the calculated first motion estimation error value exceeds the first threshold.

13. The motion type decision method of claim 11, wherein the second decision step comprises:
a second filtering step of extracting the third and the fourth high frequency signals which exceed a predetermined frequency, by filtering the third and the fourth blocks, respectively;
a second threshold setting step of setting at least one of the extracted third and fourth high frequency signals as the second threshold to determine the presence of motion in the current block; and
a second motion decision step of determining that the motion exists in the current block when the calculated second motion estimation error value exceeds the second threshold.

14. The motion type decision method of claim 11, wherein the first decision step sets the first threshold by adding at least one of the first and second high frequency signals with a predetermined noise signal, and the second decision step sets the second threshold by adding at least one of the third and fourth high frequency signals with a predetermined noise signal.

15. The motion type decision method of claim 14, wherein the first decision step sets the first threshold by adding a larger signal of the first and second high frequency signals with the noise signal, and the second decision step sets the second threshold by adding a larger signal of the third and fourth high frequency signals with the noise signal.

16. The motion type decision method of claim 11, wherein, when the first and second decision steps determine the motion of the current block to be non-zero and zero, respectively, the motion type decision step determines that the motion type of the current block is global motion, and that the estimated motion vector is accurate.

17. The motion type decision method of claim 11, wherein, when the first and second decision steps determine the motion of the current block to be non-zero, respectively, the motion decision step determines that the motion exists in the current block but the estimated motion vector is inaccurate.

18. The motion type decision method of claim 17, wherein the motion type decision step determines that the current block is an image positioned in an occlusion region of a moving image.

19. The motion type decision method of claim 11, wherein the estimated motion vector is estimated from a location having a minimum motion estimation error value among a plurality of motion estimation error values which are calculated by applying one of a bi-direction block matching and a unidirectional block matching.

20. The motion type decision method of claim 11, wherein the first and second motion estimation error values are calculated by one among a sum of absolute difference (SAD), a mean absolute difference (MAD) and a mean square error (MSE).
